(19) United States
(12) Patent Application Publication
(10) Pub. No.: US 2003/0108639 A1
(43) Pub. Date: Jun. 12, 2003

(54) INJECTION MOLDING MACHINE WITH IMPROVED GUIDING DEVICE

(75) Inventors: Camille Provencher, St-Leonard (CA); Vincenzo Coppola, Montreal-Nord (CA)

Correspondence Address: MERCHANT & GOULD, P.C., 3200 IDS Center, 80 South Eighth Street, Minneapolis, MN, 55402-2215, US

(73) Assignee: DERO ENTERPRISES INC.

(21) Appl. No.: 10/010,487

(22) Filed: Dec. 6, 2001

(51) Int. Cl. B29C 45/18

(52) U.S. Cl. 425/574

(57) ABSTRACT

An improved injection molding machine having a support frame, an injection gun, a guiding device, and a molding cavity, the guiding device being mounted to the support frame for moving the injection gun along a longitudinal axis towards and back from the molding cavity. The improvement lies in that the guiding device includes an actuator, a lever link, a coupling link, and a guiding track. The actuator is mounted to the support frame and has a piston end movable between a retracted position and an extended position. The lever link has a central portion pivotally mounted to the support frame and further includes first and second ends located respectively on both sides of the central portion, the first end of the lever link being pivotally connected to the piston end of the actuator. The coupling link has a first end pivotally connected to the second end of the lever link and a second end pivotally connected to a connection point of the injection gun, the coupling link being disposed substantially in parallel to the longitudinal axis. The guiding track is mounted to the support frame in such a manner as to extend along the longitudinal axis and cooperates with the injection gun for guiding the same along the longitudinal axis. The guiding device is devised so that a displacement of the piston end of the actuator between the retracted position and the extended position operatively moves the injection gun by means of the links and guiding track towards the molding cavity whereby the injection gun is in injection position and back from the molding cavity wherein the injection gun is in a rest position. The injection molding machine with the above-mentioned guiding device enables a decrease in molding material splashings and improved molding results. The guiding device may be mounted and dismantled very easily for quick and easy maintenance and/or part replacement of the machine.

### FIELD OF THE INVENTION

The present invention relates to an injection molding machine with an improved guiding device. More particularly, the present invention relates to an injection molding machine having a support frame, an injection gun, a molding cavity, and an improved guiding device mounted to the support frame for moving the injection gun along a longitudinal axis towards and back from the molding cavity.

### BACKGROUND OF THE INVENTION

There exist several prior art documents describing different types of die casting/injection molding machines and different types of guiding devices that may be used therewith.

Canadian Patent No. 1,099,476 granted to Frenette et al. describes a die casting machine having a frame with a base plate pivotally mounted thereon and supporting a furnace pot. A die assembly is mounted on the front face of the base plate and a double locking toggle arrangement is used to open and close the dies. The gooseneck assembly is mounted for linear movement to actuate the nozzle onto the die parting line.

Canadian Patent No. 2,024,327 granted to Yaffe et al. describes a machine for producing metal die castings. The machine comprises a crucible that incorporates an injection pump assembly which is mounted in such a way as to clear the upper access of the crucible to facilitate cover sealing and removing. The crucible is located in a furnace and is reciprocable to move the injection barrel and nozzle to and from a mold. The injection barrel is immersed in the crucible beneath the level of the molten metal to enhance heat transfer between the barrel and injected metal. The separate plunger and shot assemblies are located in the pump body in a “V” configuration so that maintenance of these units can be carried out without exposing the top of the furnace to the atmosphere. The plunger and shot assemblies include sealing means in connection with their actuating mechanisms to avoid molten metal splashing outside of the crucible when they are moving in an injection operation and to prevent the ingress of moisture, hydraulic fluid or the like into the crucible or injection chambers. This machine is particularly suitable for use with high melting point alloys such as magnesium.

Also known to the Applicant are the following Canadian patents which describe different die casting/injection molding machines and various guiding devices used therewith: 1,089,166; 1,214, 611; 1,217,917; 1,222,861; and 1,228,464.

A significant problem associated with some of the guiding devices used with the above-mentioned prior art machines is that they often lead to splashings of the molding material, which in turn results in the obstruction of the various components of the injection molding machine, thereby forcing the injection gun to cooperate with the molding cavity at an angle, and causing the nozzle of the injection gun to wear out due to its orbital displacement. Among other disadvantages, this wear caused by the orbital displacement biases the press effect of the injection molding machine, which is very undesirable for obvious reasons known in the art.

Another problem associated with some of the guiding devices of the above-mentioned prior art machines is that the contact point between the guiding device of the injection molding machine and its injection gun is fairly small, thereby leading to a pronounced localized wear of the guiding device at the contact point, resulting very often in the malfunctioning of the guiding device, and consequently inadequate operation of the injection molding machine, which is also very undesirable.

In order to overcome the above-mentioned drawbacks, one must very often remove the entire injection gun from the injection molding machine and proceed to its maintenance thereof and to the one of several other components of the injection molding machine which will often take at least four (4) hours. This is very disadvantageous for obvious maintenance and productivity reasons.

Therefore, in view of the above, there is a definite need for an injection molding machine having an improved guiding device.

### SUMMARY OF THE INVENTION

An object of the present invention is to provide an injection molding machine having a guiding device which would overcome some of the above-mentioned problems, and would thus be an improvement over the injection molding machines known in the art.

In accordance with the present invention, the above object is achieved by an improved injection molding machine comprising a support frame, an injection gun, a guiding device, and a molding cavity, the guiding device being mounted to the support frame for moving the injection gun along a longitudinal axis towards and back from the molding cavity. The improvement lies in that the guiding device comprises:

an actuator mounted to the support frame, said actuator having a piston end movable between a retracted position and an extended position;

a lever link having a central portion pivotally mounted to the support frame, said lever link further comprising first and second ends located respectively on both sides of the central portion, the first end of the lever link being pivotally connected to the piston end of the actuator;

a coupling link having a first end pivotally connected to the second end of the lever link and a second end pivotally connected to a connection point of the injection gun, said coupling link being disposed substantially in parallel to the longitudinal axis; and

a guiding track mounted to the support frame in such a manner as to extend along the longitudinal axis, said guiding track cooperating with the injection gun for guiding the same along the longitudinal axis;

wherein a displacement of the piston end of the actuator between the retracted position and the extended position operatively moves the injection gun by means of the links and guiding track towards the molding cavity wherein said injection gun is in an injection position and back from said molding cavity wherein said injection gun is in a rest position.

Preferably, the injection gun comprises an injection nozzle for injecting a molding material into the molding cavity, said injection nozzle being connected to an inlet of the molding cavity when the injection gun is in the injection position, and said injection nozzle being retracted from the inlet of the molding cavity when the injection nozzle is in the rest position.

Preferably also, the guiding track comprises at least one bar and the actuator is preferably an hydraulic actuator.

Preferably also, the lever link is V-shaped and the coupling link is straight.

The invention and its advantages will be better understood upon reading the following non-restrictive description of a preferred embodiment thereof, made with reference to the accompanying drawings.

### BRIEF DESCRIPTION OF THE DRAWINGS

FIG. 1 is a side elevational view of an injection molding machine according to the prior art, said machine being shown with its injection gun in a rest position.

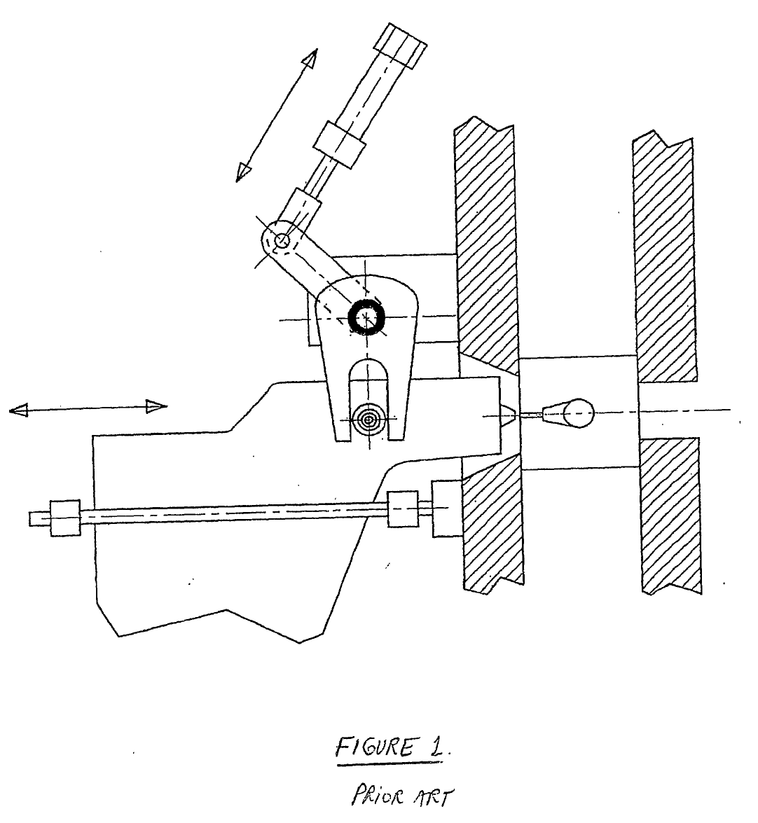

FIG. 2 is a side elevational view of an injection molding machine according to a preferred embodiment of the invention, said machine being shown with its injection gun in a rest position.

### DETAILED DESCRIPTION OF A PREFERRED EMBODIMENT OF THE INVENTION

In the following description, the same numerical references refer to similar elements. The embodiment shown in the figures is preferred only.

Moreover, although the present invention as exemplified hereinafter was primarily designed for use with zinc as a preferred molding material, it could be used with other molding materials, such as other metals, polymers, and the like, and may also be used in other fields, such as in the food industry for molding deserts for example, as apparent to a person skilled in the art. For this reason, expressions such as “zinc” and “metal” and any other references and/or other expressions equivalent thereto should not be taken as to limit the scope of the present invention and include all other molding materials and all other molding purposes with which the present invention could be used and may be useful.

In addition, although the preferred embodiment of the injection molding machine as disclosed hereinafter comprises various components such as pins, a guiding bar, etc., which are useful and present advantages, not all of these components are essential to the invention and thus should not be taken in their restrictive sense, i.e. should not be taken as to limit the scope of the present invention. It is to be understood, as also apparent to a person skilled in the art, that other suitable components and cooperations thereinbetween may be used for the injection molding machine according to the present invention, as will be described hereinafter, without departing from the scope of the invention.

Similarly, expressions such as “liquid”, “molding material”, and “zinc”, as well as any equivalent expressions and/or compound words thereof, may be used interchangeably in the context of the present description. The same applies for any other mutually equivalent expressions, such as “link” and “connector” or “injection molding” and “die casting” for example, as also apparent to a person skilled in the art.

Finally, it is to be understood that the expression “molding material”, as used in the context of the present invention, refers to various types of materials/substances which could be “molded” or “die cast” according to the present invention, as also apparent to a person skilled in the art and as will be explained hereinafter.

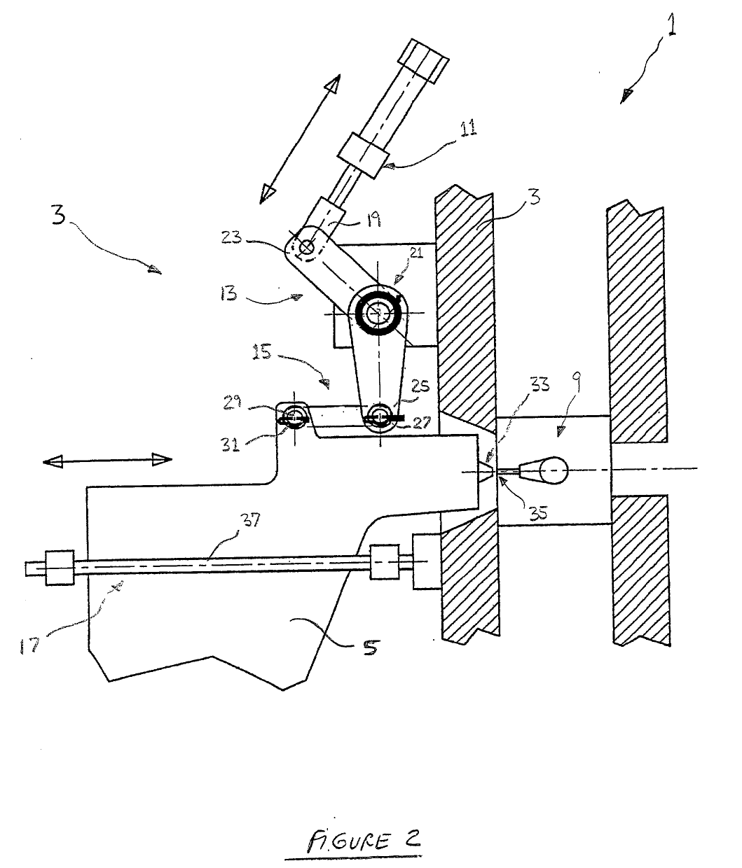

Broadly described, the injection molding machine 1 according to the preferred embodiment of the invention as it is illustrated in FIG. 2 of the accompanying drawings, is an injection molding machine 1 having a support frame 3, an injection gun 5, a guiding device 7, and a molding cavity 9, the guiding device 7 being mounted to the support frame 3 for moving the injection gun 5 along a longitudinal axis towards and back from the molding cavity 9, the improvement being in that the guiding device 7 includes an actuator 11, a lever link 13, a coupling link 15, and a guiding track 17. The actuator 11 is mounted to the support frame 3 and has a piston end 19 movable between a retracted position and an extended position. The lever link 13 has a central portion 21 pivotally mounted to the support frame 3 and further includes first and second ends 23, 25 located respectively on both sides of the central portion 21, the first end 23 of the lever link 13 being pivotally connected to the piston end 19 of the actuator 11. The coupling link 15 has a first end 27 pivotally connected to the second end 25 of the lever link 13 and a second end 29 pivotally connected to a connection point 31 of the injection gun 5, the coupling link 15 being disposed substantially in parallel to the longitudinal axis. The guiding track 17 is mounted to the support frame 3 in such a manner as to extend along the longitudinal axis and cooperates with the injection gun 5 for guiding the same along the longitudinal axis. The guiding device 7 is devised so that a displacement of the piston end 19 of the actuator 11 between the retracted position and the extended position operatively moves the injection gun 5 by means of the links 13, 15 and guiding track 17 towards the molding cavity 9 whereby the injection gun 5 is in injection position and back from the molding cavity 9 wherein the injection gun 5 is in a rest position.

As is also shown in FIG. 2, the injection gun 5 preferably comprises an injection nozzle 33 for injecting a molding material (not shown) into the molding cavity 9. The injection nozzle 33 is connected to an inlet 35 of the molding cavity 9 when the injection gun 5 is in the injection position, and the injection nozzle 33 is retracted from the inlet 35 of the molding cavity 9 when the injection nozzle 33 is in the rest position, the rest position being illustrated in FIG. 2. The nozzle 33 of the injection gun 5 and the inlet 35 of the molding cavity 9 are preferably devised to have complementary shapes, so as to enable a tighter fit thereinbetween. This enables, among other things, when combined to the above-mentioned features of the guiding device 7, to have an increased pressure effect of the injection molding machine 1 and also to prevent splashings of the molding material.

Preferably, the guiding track 17 comprises at least one bar 37, each of which is preferably cylindrical. It is worth mentioning though, as apparent to a person skilled in the art, that any other suitable guiding track 17 may be used for the guiding device 7 according to the present invention, so long as it cooperates with the injection gun 5 for supporting and/or guiding the same along the longitudinal axis, in a substantial linear relation with respect to the molding cavity 9, as explained herein.

Preferably also, as better shown in FIG. 2, the lever link 13 is V-shaped and the coupling link 15 is straight. It is to be understood that the words “V-shaped” and “straight” are not to be taken in their restrictive sense since other suitable shapes can be used for the lever link 13 and coupling link 15 respectively, as apparent to a person skilled in the art. For example, the lever link 13 may also be straight, i.e. the central portion 21 and the first and second ends 23, 25 of the lever link 13 may be “aligned” along a unique line integral to the lever link 13, such as in the case of a straight link 13. Such configuration would require, among other things, the pivot point of the lever link 13 to be further away from the support frame 3, i.e. more towards the left when seen in FIG. 2. Hence, it can be easily understood that the shape and positioning of the lever and coupling links 13, 15 will depend on the particular position of the actuator 11 and of the injection gun 5 and its connection point 31 as it cooperates with the guiding track 17. The V-shaped configuration of the lever link 13 and the straight configuration of the coupling link 15 are merely preferred embodiments of the invention, and as explained herein, other suitable shapes and configurations may be used, as apparent to a person skilled in the art. Indeed, a main role of the lever link 13 is to transmit the force from the actuator 11 to the injection gun 5 by means of the coupling link 15, the latter being designed primarily to pull and push back the injection gun 5 in a direction substantially parallel to the longitudinal axis of the support frame 3 and with an increased contact area.

According to the preferred embodiment of the invention, the actuator 11 is an hydraulic actuator and the lever and coupling links 13, 15 are preferably made out of suitable materials, such as metals, alloys, fiber-reinforced materials, etc., for example. It is worth noting that other suitable types of actuators 11 may be used for the guiding device 7 and that depending on the geometrical and dynamical disposition of the actuator 11 and of the lever link 13 as well as the interaction thereinbetween, a certain slack may be required between the piston end 19 of the actuator 11 and the first end 23 of the lever link 13, as apparent to a person skilled in the art. For example, according to the preferred embodiment of the invention as illustrated in FIG. 2, the end of the actuator 11 which is mounted to the support frame 3 is preferably mounted thereon in a pivotable manner, thereby allowing the piston end 19 of the actuator 11 to be connected to the first end 23 of the lever link 13 by means of an appropriate connector, such as a suitable pin for example. It can be easily understood that if the end of the actuator 11 mounted to the support frame 3 is rigidly mounted thereon, then a certain slack or different connection means will be required between the piston end 19 of the actuator 11 and the first end 23 of the lever link 13 so as to enable the latter to move along a proper circular path about the pivot point of the central portion 21 of the lever link 13, thereby enabling the second end 25 of the lever link 13 to pull and push back on the connection point 31 of the injection gun by means of the coupling link 15.

The molding material is preferably zinc. It is worth noting however that other suitable molding materials, such as other metals, polymers, and the like, may be used with the present invention, as also apparent to a person skilled in the art. Preferably, the molding material is injected under pressure into the inlet 35 of the molding cavity 9 when the injection gun 5 is in the injection position.

By virtue of its design and its different components, some of the main functions of the guiding device 7 are to move the injection gun 5 towards and back from the inlet 35 of the molding cavity 9 in a substantially straight line; to hold the injection nozzle 35 of the injection gun 5 firmly against the inlet 35 of the molding cavity 9 in order to avoid splashings of molding material during the injection stage; and to move the injection gun 5 away from the molding cavity 9 without any shocks thereto.

As may now be appreciated, the injection molding machine 1 according to the present invention, as described hereinabove, is an improvement over the prior art in that, as explained herein, the guiding device 7 of the machine 1 enables to avoid splashings of the molding material being molded with the injection gun 5 into the molding cavity 9, thereby improving the operation of the injection molding machine 1 and decreasing the amount of material wasted and also lowering the amount of maintenance required which leads to increased productivity and efficiency.

Furthermore, the injection molding machine I according to the present invention is also advantageous in that it comprises a guiding device 7 enabling a more adequate and stable alignment of the injection gun 5 with respect to the molding cavity 9, thereby resolving orbital displacement problem and enabling to obtain improved molding results and less splashings, and consequently less material waste during the molding operation, leading once again to an increased productivity and efficiency.

The injection molding machine 1 according to the present invention is further advantageous in that its guiding device 7 can be mounted and dismantled very easily for quick and easy maintenance and/or part replacement of the machine 1.

Of course, numerous modifications can be made to the above-described embodiments without departing from the scope of the invention as described in the appended claims.

1. In an injection molding machine comprising a support frame, an injection gun, a guiding device, and a molding cavity, the guiding device being mounted to the support frame for moving the injection gun along a longitudinal axis towards and back from the molding cavity, the improvement wherein the guiding device comprises:
an actuator mounted to the support frame, said actuator having a piston end movable between a retracted position and an extended position;
a lever link having a central portion pivotally mounted to the support frame, said lever link further comprising first and second ends located respectively on both sides of the central portion, the first end of the lever link being pivotally connected to the piston end of the actuator;
a coupling link having a first end pivotally connected to the second end of the lever link and a second end pivotally connected to a connection point of the injection gun, said coupling link being disposed substantially in parallel to the longitudinal axis; and
a guiding track mounted to the support frame in such a manner as to extend along the longitudinal axis, said guiding track cooperating with the injection gun for guiding the same along the longitudinal axis;
wherein a displacement of the piston end of the actuator between the retracted position and the extended position operatively moves the injection gun by means of the links and guiding track towards the molding cavity wherein said injection gun is in an injection position and back from said molding cavity wherein said injection gun is in a rest position.

2. The improved injection molding machine according to claim 1, wherein the injection gun comprises an injection nozzle for injecting a molding material into the molding cavity, said injection nozzle being connected to an inlet of the molding cavity when the injection gun is in the injection position, and said injection nozzle being retracted from the inlet of the molding cavity when the injection nozzle is in the rest position.

3. The improved injection molding machine according to claim 2, wherein the guiding track comprises at least one bar.

4. The improved injection molding machine according to claim 3, wherein said at least one bar is a cylindrical bar.

5. The improved injection molding machine according to claim 1, wherein the actuator is an hydraulic actuator.

6. The improved injection molding machine according to claim 1, wherein the lever link is V-shaped.

7. The improved injection molding machine according to claim 1, wherein the coupling link is straight.

8. In an injection molding machine comprising a support frame, an injection gun, a guiding device, and a molding cavity, the guiding device being mounted to the support frame for moving the injection gun along a longitudinal axis towards and back from the molding cavity, the improvement wherein the guiding device comprises:
an actuator mounted to the support frame, said actuator having a piston end movable between a retracted position and an extended position;
a lever link having a central portion pivotally mounted to the support frame, said lever link further comprising first and second ends located respectively on both sides of the central portion, the first end of the lever link being pivotally connected to the piston end of the actuator;
a coupling link having a first end pivotally connected to the second end of the lever link and a second end pivotally connected to a connection point of the injection gun, said coupling link being disposed substantially in parallel to the longitudinal axis; and
a guiding track mounted to the support frame in such a manner as to extend along the longitudinal axis, said guiding track cooperating with the injection gun for guiding the same along the longitudinal axis;
wherein a displacement of the piston end of the actuator between the retracted position and the extended position operatively moves the injection gun by means of the links and guiding track towards the molding cavity wherein said injection gun is in an injection position and back from said molding cavity wherein said injection gun is in a rest position; wherein the injection gun comprises an injection nozzle for injecting a molding material into the molding cavity, said injection nozzle being connected to an inlet of the molding cavity when the injection gun is in the injection position, and said injection nozzle being retracted from the inlet of the molding cavity when the injection nozzle is in the rest position; wherein the guiding track comprises at least one bar; wherein the lever link is V-shaped; and wherein the coupling link is straight.
